(19) United States
(12) Patent Application Publication
(10) Pub. No.: US 2021/0053250 A1
(43) Pub. Date: Feb. 25, 2021

(54) APPARATUS AND METHOD FOR PRODUCING A PAVER BLOCK HAVING VEINED TREAD SURFACE

(71) Applicant: Árpád BARABÁS, Veszprém (HU)

(72) Inventor: Árpád BARABÁS, Veszprém (HU)

(21) Appl. No.: 16/492,649

(22) PCT Filed: Mar. 7, 2018
(86) PCT No.: PCT/HU2018/050016

§ 371 Date: Sep. 10, 2019

(30) Foreign Application Priority Data
Mar. 10, 2017 (HU) P17 00104

(51) Int. Cl. B28B 1/00; B28B 13/02; B44F 9/04

(52) U.S. Cl. CPC B28B 1/005; B28B 13/022; B44F 9/04; B28B 13/0225; B28B 13/023

(57) ABSTRACT

This invention relates to an apparatus and method for producing paver blocks (K) having ornamented, especially veined tread surface. The apparatus comprising a starting table (51); a filling carriage (5) movable back and forth in a first direction (F1) above a molding template (6); and an open chamber (5a) for receiving a base material is provided in the interior space of the carriage (5); a metering trough (1, 2, 3) is connected to a dispensing device (41), and a batch box (4) is arranged movably over the starting table (51). The apparatus is provided with a second starting table (8) movable in a second direction (F2) above the molding template (6), and a second filling carriage (7) is arranged movably along a guide rail (32) over the molding template (6) in the second direction (F2), and a second batch box (9) is provided above the second filling carriage (7).

The invention relates to an apparatus for producing a paver block having veined tread surface, the apparatus comprising: a starting table; a filling carriage connected to the starting table and movable back and forth in a first direction along a guide rail above a molding template having at least one mold cavity; and a chamber being open both at its upper and lower sides for receiving a base material is provided in the interior space of the carriage and metering trough connected to a dispensing device, and a method for producing a paver block having veined tread surface, wherein a first metering trough of the apparatus being filled with a base material colored by a first dyestuff and a second metering trough being filled with a base material colored by a second dyestuff, a and the base material being fed from the trough into the mold cavity of the moulding pattern.

Paving elements are now indispensable for making different pathways, patios, sidewalks, garden paths, and even roadways designed for vehicle transportation, whereby covering the road surface with pre-manufactured and juxtaposed pavers being generally similar in size to the size of conventional bricks and usually made of concrete, rather than subsequently solidified material, for example poured concrete or asphalt. Since paver blocks can be made in varied shape and surface quality, they are particularly suitable for forming aesthetic walking surfaces, that is the need for paving blocks made firstly of concrete having appealing surface continues to grow. The vast majority of concrete paver blocks having an eye-catching surface differ from the rectangular concrete-gray pavers by the color of the surface and/or the shape of the block, and their color is usually obtained by using a concrete base material mixed with a coloring agent, like a dyestuff. Although it is possible to achieve an aesthetic effect by juxtaposing paving blocks provided even by differently colored surfaces, a more pronounced demand is emerging for paving blocks having a patterned tread surface especially those resembling natural rock surfaces. Such rocks are e.g. marble, granite or diorite. Therefore, colored paving blocks have been developed, the concrete base material of which contains additive grains with diversified shape and different in color from those of the concrete, consequently the tread surface of the paver becomes grainy, requiring washing, grinding, wearing or other surface processing. However, a serious drawback of this solution is that the production of such a paver element is much more expensive than even the base-material-colored paving blocks, because the additives being more expensive than the base material must be dispersed of the total volume of the base material, let alone expensive reworking.

The aforesaid disadvantages are addressed by EP 3 095 768 A1, which discloses a process for producing a cast stone having a patterned surface looking like a vascular system. In the process, the first material mixture for molding and solidifying is poured into a mould of the size to be made and then a template containing a ribbing corresponding to a predetermined groove pattern is deepened in the upper surface of the mixture, and the pattern of grooves thus formed can be filled by the second material blend for molding and solidifying having a color different from that of the first material, such that second material blend delivered to the grooves from a nozzle mounted on an automated robotic arm that follows the groove pattern. After the mixture is compacted and solidified, the element is removed from the mold. Although this solution can substantially eliminate these disadvantages, we can face further disadvantages, because the use of the robot arm requires relatively expensive investment, and filling of the grooves from a nozzle on the robotic arm is a rather lengthy process that significantly increases the cost of the product. Further disadvantage is that the surface pattern thus obtained is not a random one, therefore, elements having the same pattern, which may be close to each other in use, will worsen or even destroy the spontaneous, natural effect of the surface.

The object of the present invention is therefore to provide an apparatus and a process for producing concrete paving elements having veined surface to eliminate the disadvantages of the prior art technical solutions and allow concrete paving elements obtained by random surface pattern resembling natural marble to be produced by the same production cycle times as production of paving elements having no any surface pattern, and which can be used to create spontaneous, natural-looking surface patterns.

The object of this invention can be achieved by providing an apparatus for producing a paver block having veined tread surface, the apparatus comprising: a starting table; a filling carriage being movable back and forth in a first direction along a guide rail above a molding template connected to the starting table and having at least one mold cavity; and a chamber being open both at its upper and lower sides for receiving a base material is provided in the interior space of the carriage; metering trough connected to a dispensing device, and a batch box to be loaded by the dispensing device and provided with an open top and an emptying device at its lower side is arranged movably over the starting table on a plane parallel to the plane of the starting table; and the apparatus is provided with a further, second starting table movable in a second direction along a guide rail above the molding template, a second filling carriage provided with chambers open both upper and lower sides is arranged movably along a guide rail over the molding template in the second direction above the starting table, and a second batch box with open top and lower sides is provided above the second filling carriage, and the apparatus is provided with at least two metering trough.

The second batch box is in a fixed position relative to the guide rail.

The second batch box is movable in the second direction along the guide rail.

The first direction and the second direction include an angle of n*π/2, where n is a natural number.

The second carriage is formed as a plate and the chambers open both at bottom and top sides are holes.

Chambers open both at top and bottom of the second filling carriage are formed as a slot system.

The dispensing device is a screw dispenser.

The base material is selected from the group consisting of concrete mortars colored in its material and uncoloured concrete mortar.

The object of this invention can also be achieved by providing method for producing a paver block having veined tread surface by means of the apparatus according to the invention, wherein a first metering trough of the apparatus being filled with a base material colored by a first dyestuff and a second metering trough being filled with a base material colored by a second dyestuff, a and the base material being fed from the trough into the mold cavity of the moulding pattern, then compacted and allowed to be set, dividing an inner space of a filling carriage placed on a starting table into target areas, and during feeding the base material in the mold cavity,
a) a part of the base material is fed into a batch box from the trough, batch box is moved over the selected target area of the interior space of the filling carriage, dispensing device of the batch box is activated to feed the base material from the batch box to the target area, then
b) repeating step a) for filling all other target areas, and
c) moving the filling carriage from the starting table in the first direction over the molding template and retracting it,
filling up with base material a batch box with bottom and top openings arranged above the second filling carriage located on the second starting table, and filling the open chambers of the second carriage from the second batch box, and then moving the second filling carriage together with the second starting table in a second direction over the molding template, and retracting the second starting table in the second direction, thereby feeding the base material arranged in the open chambers into the surface of the base material fed in the molding template during the step c).
Filling up the open chambers of the second filling carriage from the second batch box is achieved by moving the second batch box in the second direction.
The second filling carriage is formed as a sheet and the open chambers of the second filling carriage are formed as holes.
The chambers open at the top and bottom of the second filling carriage are formed as a system of slits.
Selecting the base material from the group consisting of concrete mortars colored in its material and uncoloured concrete mortar.

The invention will now be described in more detail with reference to the accompanying drawings and to its preferred embodiments. In the drawing

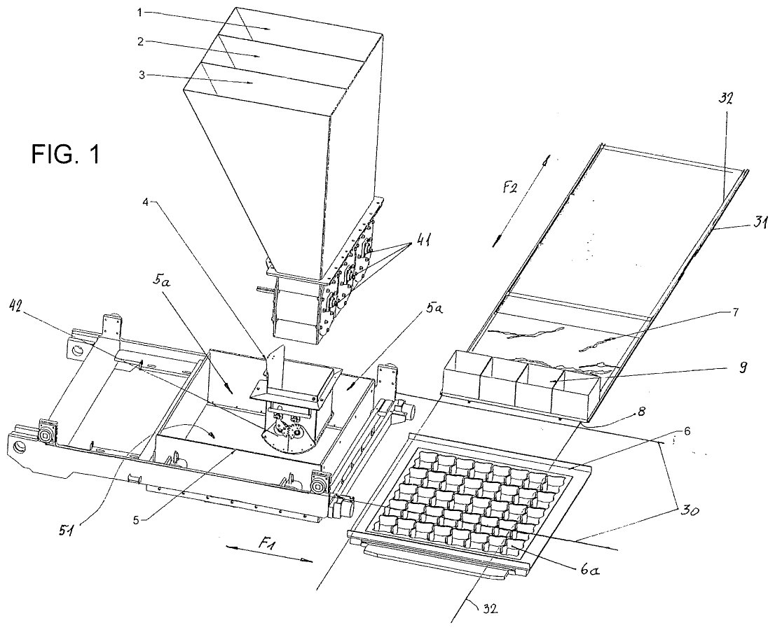

FIG. 1 is a schematic representation of a preferred embodiment of the apparatus according to the present invention,

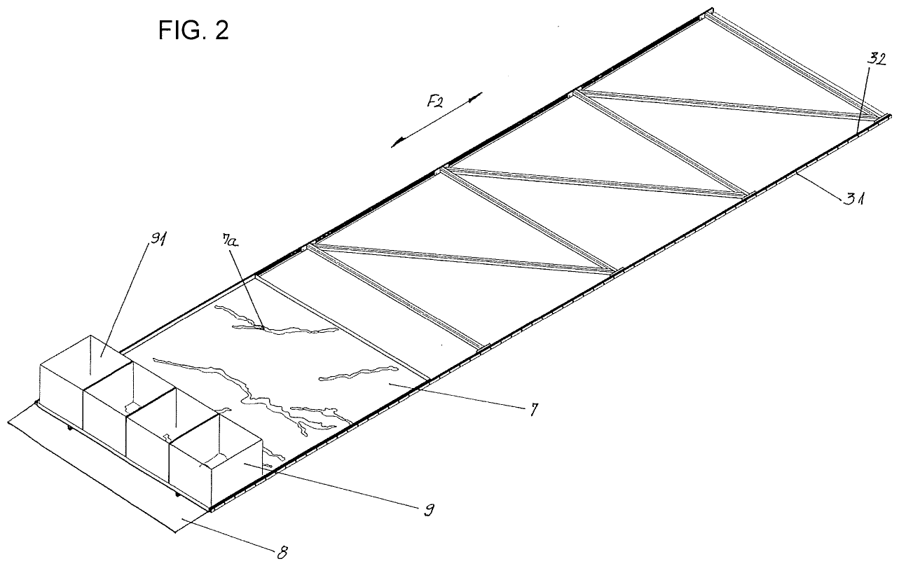

FIG. 2 depicts a filling carriage having a system of slots used in the apparatus according to the invention, and

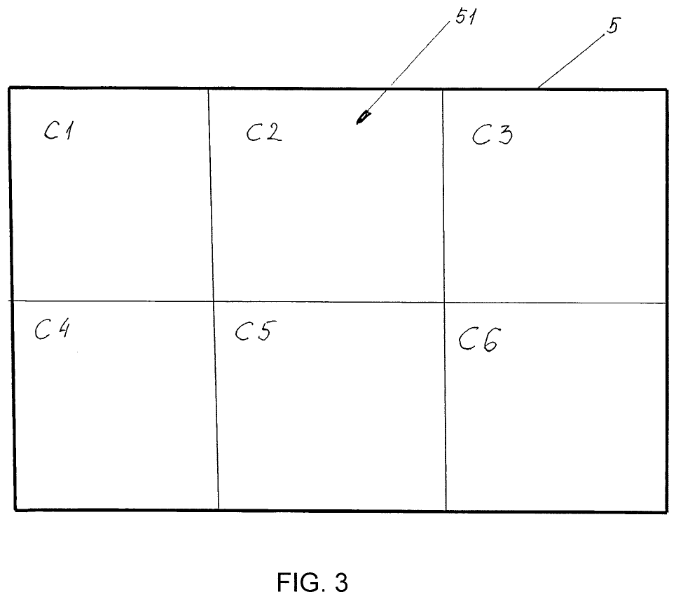

FIG. 3 shows how a starting table can be divided into target areas.

FIG. 1 is a schematic representation of a preferred embodiment of the apparatus for making a paver block having veined tread surface according to the invention. In this embodiment a filling carriage 5 with open top and bottom is provided over a starting table 51 of the apparatus according to the invention, which carriage 5 is movable back and forth from the starting table 51 in a first direction F1 along a guide rail 30 above a molding template 6 connected to the starting table 51 and having at least one, but advantageously several mold cavity(ies) 6a, so that it can be pulled back to the starting table 51. The inner space of the carriage 5 forms an chamber 5a being open both underneath and above, which is for receiving a colored or uncolored material, e.g. concrete grout, from which we can make the bulk of the volume of paving elements K to be produced.

The apparatus is provided with a metering trough 1, 2, 3 connected to the dispensing device 41, three of which are shown in the figure. In metering troughs 1, 2, 3 tinted or uncoloured material, e.g. concrete mortar is disposed. Above the starting table 51 a batch box 4 open at its top is arranged, which can be charged from the metering trough 1, 2, 3 by means of the dispensing device 41 and can be moved in a plane parallel to the plane of the table 51. The batch box 4 is provided with an inferior emptying device 42 to allow the concrete mortar to be fallen into the chamber 5a, that is to a predetermined area A, B, C, of the table 51 by moving over this respective area A,B,C then opening the emptying device 42. Any arrangement known to one skilled in the art can be used as an emptying device 42.

The apparatus according to the invention further comprising a second, sheet like starting table 8 movable and retractable over the molding template 6 in a second direction F2 along a second guide rail 31. The first direction F1 and the second direction F2 preferably include an angle α of n*π/2, e.g. in case of n=1, this angle is 90°, where n is a natural number. Above the second starting table 8 a second carriage 7 formed with chambers 7a open top and bottom is provided, which is movable and retractable over the molding template 6 in a second direction F2 along a guide rail 32 independently from starting table 8. In the preferred embodiment shown in FIG. 7 the second carriage 7 is formed as a sheet or plate, and its open chambers 7a are formed as a slot system, as it is shown in FIG. 2.

A second batch box 9 divided into several chambers 91 open at their top and bottom as well is fitted on the second filling carriage 7 from above. The chambers 91 of the second batch box 9 can be loaded with colored or uncolored concrete mortar either from any of the metering trough 1, 2, 3 or from dispensing trough similar to those shown in the Figure. The second batch box 9 is preferably in a fixed position relative to the guide rails 31, 32, but it is also conceivable that in a preferred embodiment it can be slid in the direction F2 over the carriage 7 on an additional rail, so that the chambers 7a of the carriage 7 can be charged with the concrete mortar pre-filled in the batch box 9.

If the filling carriage 7 is placed in its entirety above the plate-like starting table 8, the starting table 8 prevents the concrete mortar from falling out of chambers 7a.

A method according to the present invention for producing a paver block K having veined tread surface according to the invention can be accomplished by means of the apparatus as described, wherein at least two metering troughs 1, 2, 3 of the apparatus are filled, such that a first metering trough 1 is filled with a base material colored by a first manner, a second metering trough 2 is filled with a base material colored by a second manner and the third metering trough 1 is filled with an uncolored base material e.g. uncoloured concrete mortar. Subsequently, the base material materials are transferred from the metering troughs 1, 2, 3 to the mold cavity 6a of the molding pattern 6 by dividing firstly the interior space of the filling carriage 5 arranged on the starting table 51 into target areas C1, C2, C3, C4, C5, C6, as shown in FIG. 3. The number of target areas C1, C2, C3, C4, C5, C6 is arbitrary, but not more than the ratio of the surface area of the starting table 51 inside the filling carriage 5 and the cross-section area of the batch box 4 measured parallelly to the starting table 51, the integer part of that ratio, exactly. Then, some of the base material, e.g. from the metering trough 1 is transferred to the batch box 4 by moving the batch box 4 under the metering trough 1 and filling it with the base material by operating the dispensing device 41 comprising e.g. a screw dispenser. In the next step the batch box 4 is moved above the starting table 51 over a selected target area C1, C2, C3, C4, C5, C6 inside the filling carriage 5 and the emptying device 42 of the batch box 4 is operated. This way the selected base material is transferred from the batch box 4 to a selected target area C1, C2, C3, C4, C5, C6, e.g. to the target area C1. This step will be followed in order to fill all other areas C2, C3, C4, C5, C6. If all target areas C1, C2, C3, C4, C5, C6 are filled with some base material, the filling carriage 5 is moved from the starting table 51 over the molding pattern 6 and retracted along the first direction F1. As a result, the mold cavities 6a of the molding pattern 6 are filled with base material and the filling carriage 5 is returned to its initial position. The material in the moulding pattern 6 is compacted e.g. by vibrating the moulding pattern 6 or by another means well known in the art.

Subsequently, the second batch box 9 open at the bottom and top as well, which is arranged above the second carriage 7 on the second starting table 8 is loaded with a base material, while the second carriage 7 closes the bottom of the batch box 9, and the second carriage 7 is entirely located under the second starting table 8, which thus closes the bottom of the open chambers 7a.

The chambers 7a of the second carriage 7 are then charged from the second batch box 9, so that the second carriage 7 on the rails 31, 32 is moved under the batch box 9 along with the starting table 8.

Thereafter, the second carriage 7 is moved further in the second direction F2 over the moulding pattern 6 along with the second starting table 8, and the second starting table 8 is retracted in the second direction F2. Thus, the base material arranged in the open chambers 7a is applied to the surface of the base material previously applied in the moulding pattern 6.

That is, a portion of the base material is transferred to the batch box 4 from the metering trough 1 during the process, the batch box 4 is moved above the starting table 51 over a selected target area C1 inside the filling carriage 5 and the emptying device 42 of the batch box 4 is operated, and this way the selected base material is transferred from the batch box 4 to a selected target area C1 and all other C2, C3, C4, C5, C6 target areas are loaded in a similar manner and the carriage 5 is moved from the starting table 51 in the first F1 direction over the moulding pattern 6 and retracted. Thereafter, filling up with base material the batch box 9 having bottom and top openings arranged above the second filling carriage 7 located on the second starting table (8), and filling the open chambers 7a of the second carriage 7 from the second batch box 9, e.g. by moving the second filling carriage 7 together with the second starting table 8 in a second direction F2 under the second batch box (9), or by moving the second batch box 9 over the second filling carriage 7 in a second direction F2, moving the second filling carriage 7 along with the second starting table 8 in the second direction F2 over the moulding pattern 6, then retracting the second starting table 8 in the second direction F2, thereby feeding the base material arranged in the open chambers 7a into the surface of the base material fed in the molding template 6. The material arranged in the cavities 6a is compacted and allowed to solidify.

Although the cycle time of manufacture for the paving blocks K having veined tread surface made by the method according to the present invention is somewhat longer than that of the blocks produced without any surface treatment, it is much shorter than the cycle time of production for the molded paving blocks of the prior art having veined surface.

The advantage of the apparatus and method for producing a paver block K preferably made of concrete and having veined tread surface in relation to the prior art solutions is that allowing concrete paving elements obtained by random surface pattern resembling natural marble to be produced by almost the same production cycle times as production of paving elements having no any surface pattern, which can be used to create spontaneous, natural-looking surface patterns at the same time.

1. An apparatus for producing a paver block (K) having veined tread surface, the apparatus comprising: a starting table (51); a filling carriage (5) being movable back and forth in a first direction (F1) along a guide rail (3) above a molding template (6) connected to the starting table (51) and having at least one mold cavity (6a); and a chamber (5a) being open both at its upper and lower sides for receiving a base material is provided in the interior space of the carriage (5); metering trough (1, 2, 3) connected to a dispensing device (41); and the apparatus is provided with a further, second starting table (8), and a second filling carriage (7) arranged movably along a guide rail (32) over the molding template (6) in the second direction (F2) above the starting table (8), and the apparatus is provided with at least two metering trough (1, 2, 3); and a batch box (4) to be loaded by the dispensing device (41), characterized in that the batch box (4) provided with an open top and an emptying device (42) at its lower side is arranged movably over the starting table (51) on a plane parallel to the plane of the starting table (51); and the second starting table (8) being movable in a second direction (F2) along a guide rail (31) above the molding template (6), the second filling carriage (7) is provided with chambers (7a) open both upper and lower sides; and a second batch box (9) with open top and lower sides is provided above the second filling carriage (7).

2. The apparatus according to claim 1, wherein the second batch box (9) is in a fixed position relative to the guide rail (32).

3. The apparatus according to claim 1, wherein the second batch box (9) is movable in the second direction (F2) along the guide rail (32).

4. The apparatus according to claim 1, wherein the first direction (F1) and the second direction (F2) include an angle (α) of n*π/2, where n is a natural number.

5. The apparatus according to claim 1, wherein the second carriage (7) is formed as a plate and the chambers open both at bottom and top sides are holes (7a).

6. The apparatus according to claim 1, wherein chambers (7a) open both at top and bottom of the second filling carriage (7) are formed as a slot system.

7. The apparatus according to claim 1, wherein the dispensing device (41) is a screw dispenser.

8. The apparatus according to claim 1, wherein the base material is selected from the group consisting of concrete mortars colored in its material and uncoloured concrete mortar.

9. A method for producing a paver block (K) having veined tread surface by means of the apparatus according to claim 1, wherein first metering trough (1) of the apparatus being filled with a base material colored by a first dyestuff and a second metering trough (2) being filled with a base material colored by a second dyestuff, and the base material being fed from the trough (1,2) into the mold cavity (6a) of the moulding pattern (6), then compacted and allowed to be set, by dividing an inner space of a filling carriage (5) placed on a starting table (51) into target areas (C1, C2, C3, C4, C5, C6), and during feeding the base material in the mold cavity (6a),
a) a part of the base material is fed into a batch box (4) from the trough (1), batch box (4) is moved over the selected target area (C1) of the interior space of the filling carriage (5), dispensing device (41) of the batch box (4) is activated to feed the base material from the batch box (4) to the target area (C1), then
b) repeating step a) by filling all other target areas (C2, C3, C4, C5, C6), and
c) moving the filling carriage (5) from the starting table (51) in the first direction (F1) over the molding template (6) and retracting it, characterized by
filling up with base material a batch box (9) with bottom and top openings arranged above the second filling carriage (7) located on the second starting table (8), and filling the open chambers (7a) of the second carriage (7) from the second batch box (9), and then moving the second filling carriage (7) together with the second starting table (8) in a second direction (F2) over the molding template (6), and retracting the second starting table (8) in the second direction (F2), thereby feeding the base material arranged in the open chambers (7a) into the surface of the base material fed in the molding template (6) during the step c).

10. The method according to claim 9, further comprising filling up the open chambers (7a) of the second filling carriage (7) from the second batch box (9) by moving the second batch box (9) in the second direction (F2).

11. The method according to claim 9, wherein the second filling carriage (7) is formed as a sheet and the open chambers (7a) of the second filling carriage (7) are formed as holes.

12. The method according to claim 11, wherein the chambers (7a) open at the top and bottom of the second filling carriage (7) are formed as a system of slits.

13. The method according to claim 12, wherein the base material is selected from the group consisting of concrete mortars colored in its material and uncoloured concrete mortar.
